(19) United States
(12) Patent Application Publication
(10) Pub. No.: US 2015/0151610 A1
(43) Pub. Date: Jun. 4, 2015

(54) REFRIGERATION SYSTEM FOR A MOTOR VEHICLE WITH A MID-ENGINE OR REAR ENGINE AND METHOD FOR AIR-CONDITIONING A MOTOR VEHICLE WITH A MID OR REAR ENGINE

(71) Applicant: Dr. Ing. h.c. F. Porsche Aktiengesellschaft, Stuttgart (DE)

(72) Inventors: Stefan Kraiss, Schoemberg (DE); Michael Augull, Holzgerlingen (DE)

(21) Appl. No.: 14/547,419

(22) Filed: Nov. 19, 2014

(30) Foreign Application Priority Data
Nov. 29, 2013 (DE) 10 2013 113 229.4

(51) Int. Cl. B60H 1/32

(52) U.S. Cl. CPC B60H 1/3204; B60H 1/3205

(57) ABSTRACT

A refrigeration system (10) for a motor vehicle with a mid or rear engine has an air-conditioning compressor (12) can be driven by the mid or rear engine for delivering a coolant. At least one evaporator (16) is provided for cooling a frontal part of the passenger compartment by evaporating the coolant. At least one condenser (22) condenses the coolant and a heat exchanger (20) cools the coolant flowing to the evaporator (16) with cold from the coolant coming from the evaporator (16). A control unit (26) limits a temperature of the coolant entering the air-conditioning compressor (12) to avoid a temperature that is damaging for the air-conditioning compressor (12), while also taking account of heating of the coolant along a particularly long flow path from the rear area (18) of the motor vehicle to the air-conditioning compressor (12) arranged at the mid or rear engine.

### CROSS REFERENCE TO RELATED APPLICATION

This application claims priority under 35 USC 119 to German Patent Appl. No. 10 2013 113 229.4 filed on Nov. 29, 2013, the entire disclosure of which is incorporated herein by reference.

### BACKGROUND

1. Field of the Invention

The invention relates to a refrigeration system for a motor vehicle with a mid or rear engine and to a method for air conditioning a motor vehicle with a mid or rear engine, with the aid of which a passenger compartment of the motor vehicle can be air conditioned.

2. Description of the Related Art

U.S. 2002/0078698 discloses a refrigeration system for a motor vehicle, in which a coolant is delivered to an evaporator by an air-conditioning compressor. The coolant emerging from the evaporator is heated in a heat exchanger by the coolant entering the evaporator to ensure that no droplets condense out of the coolant emerging from the evaporator. A controlled flow valve is arranged between the evaporator and the heat exchanger and is controlled so that the coolant directed from the evaporator to the heat exchanger is just sufficient to ensure that a particularly high temperature is achieved for the coolant emerging from the evaporator, thereby ensuring that the coolant enters the air-conditioning compressor in purely gaseous form, without liquid droplets, as far as possible away from the boiling point.

There is a constant need to operate a refrigeration system for a motor vehicle that has a long service life. Accordingly, an object of the invention is to provide a refrigeration system for a motor vehicle that has a long service life.

### SUMMARY OF THE INVENTION

The invention provides a refrigeration system for a motor vehicle with a mid-engine or rear engine. The refrigeration system has an air-conditioning compressor that can be driven by the mid or rear engine for delivering a coolant. The refrigeration system also has at least one evaporator for cooling a frontal part of the passenger compartment by evaporating the coolant. At least one condenser is provided for condensing the coolant. The refrigeration system further has a heat exchanger for cooling the coolant flowing to the evaporator with cold from the coolant coming from the evaporator, and a control unit for limiting a temperature of the coolant entering the air-conditioning compressor.

The control unit avoids a situation where the temperature of the coolant increases above a predefined limiting temperature. This avoids a situation where the coolant enters the air-conditioning compressor at a temperature that is too high. It is therefore possible to avoid operating the air-conditioning compressor at a temperature that is too high, thereby avoiding thermal overloading and/or unnecessary wear on the air-conditioning compressor. The risk of damage and/or failure of the air-conditioning compressor is reduced, thus ensuring a long service life of the refrigeration system.

The invention makes use of the insight that the coolant coming from the evaporator undergoes a significant temperature increase, by 10° K to 20° K for example, due to the heat exchanger. Additionally, a motor vehicle with a mid or rear engine requires the coolant to travel a particularly long distance from a front area of the motor vehicle, where cooling is to take place, to the air-conditioning compressor that is arranged at the engine of the motor vehicle. The long distance of travel causes the coolant that leaves the evaporator at about 0° C., for example, to be heated by a significant temperature difference with respect to the ambient temperature. A motor vehicle with a front-mounted engine has significantly shorter distances of travel for the coolant than a motor vehicle with a mid or rear engine and, as a result, the coolant can be heated up by a particularly large amount, e.g. up to the level of ambient temperature. In addition, the heat produced by the engine of the motor vehicle can heat the coolant further, resulting in the possibility of an extremely high coolant temperature, especially in the case of high ambient temperatures in summer and a high engine temperature at high engine speeds. If the temperature of the coolant at the inlet of the air-conditioning compressor were not limited, the coolant temperature after compression of the coolant in the air-conditioning compressor could be so high that the intended correct operation of the air-conditioning compressor could no longer be guaranteed. By limiting the temperature of the coolant at the inlet to the air-conditioning compressor, it is possible to avoid a temperature that is damaging for the air-conditioning compressor, even taking into account heating of the coolant along a particularly long flow path from the front area of the motor vehicle to the air-conditioning compressor arranged at the mid or rear engine. Thus, a refrigeration system for a motor vehicle has a long service life.

The refrigeration system can be part of an air-conditioning system for cooling and/or heating the passenger compartment. The refrigeration system preferably can be used at least in part to heat the passenger compartment, e.g. using the air-conditioning compressor. In particular, the coolant can be used both for cooling and for heating the passenger compartment. The refrigeration system can have a reservoir for holding and storing the coolant in the predominantly liquid state. The evaporator is arranged in the passenger compartment, while the condenser is positioned at a distance from the passenger compartment. The condenser preferably is positioned at a point where the condenser can be cooled by the relative wind. For example, the condenser can be arranged in a front area or rear area of the motor vehicle. The heat exchanger is suitable for co-current flow or for counter-current flow. The individual component parts of the refrigeration system are connected to one another by suitable fluid lines to carry the coolant through the individual component parts and to form a closed cooling circuit.

The control unit can vary the volume flow of the coolant within a cooling circuit of the refrigeration system. In addition or as an alternative, the control unit can control the operation of devices in the refrigeration system in which the coolant is cooled and/or heated to increase a cooling effect and/or reduce a heating effect. It is furthermore possible, when required, for the control unit to switch on an external cooling system to cool the coolant. The control unit may be connected to a sensor system that makes it possible to calculate or at least estimate the temperature of the coolant at the inlet of the air-conditioning compressor, either directly or indirectly. The control unit may be connected to a vehicle information system, in particular a CAN bus, from which the control unit can obtain data that make it possible to calculate or at least estimate the temperature of the coolant at the inlet of the air-conditioning compressor, either directly or indirectly.

The control unit may be connected to the air-conditioning compressor. Thus, the control unit is adopted to set a reduction in the operating capacity of the air-conditioning compressor to reduce the temperature of the coolant entering the air-conditioning compressor. If the temperature of the coolant is too high, the control unit can reduce the capacity of the air-conditioning compressor to protect the air-conditioning compressor. The lower delivery rate and/or lower compression ratio of the air-conditioning compressor make it possible to avoid a coolant temperature that is too high.

The control unit may be connected to an expansion valve, assigned to the evaporator, for the expansion of the coolant. Thus, the control unit is adapted to set a reduction in the expansion of the coolant in the expansion valve and/or in the evaporator to reduce the temperature of the coolant entering the air-conditioning compressor. The expansion valve preferably is configured as an electrically controllable valve that can be activated electrically by the control unit. The expansion valve can ensure that the coolant is introduced into the evaporator substantially at the boiling point. If the temperature of the coolant is too high, the expansion valve can cool the coolant to a temperature that is below the boiling temperature by a suitable amount, thus making it possible to achieve an additional cooling effect on the coolant by means of the expansion valve.

As a particularly preferred option, a bypass line, connected by way of a bypass valve, for diverting at least some of the coolant flowing to the evaporator or of the coolant coming from the evaporator past the heat exchanger is provided, wherein the control unit is connected to the bypass valve, wherein, in particular, the control unit is adapted to set an increase in the volume flow flowing via the bypass line in order to reduce the temperature of the coolant entering the air-conditioning compressor. The bypass valve can be provided as a branch valve at a point of connection for the bypass line, for example, or can be arranged as a shutoff valve in the bypass line. By means of the bypass line, at least some of the coolant can be diverted past the heat exchanger, thereby making it possible to reduce the heat transfer capacity of the heat exchanger. It is thereby possible to reduce or even eliminate heating-up of the coolant leaving the evaporator by the heat exchanger.

In particular, a temperature sensor is provided at an inlet of the air-conditioning compressor in order to measure the temperature of the coolant entering the air-conditioning compressor, wherein the temperature sensor is connected to the control unit. The temperature sensor allows direct and very accurate measurement of the temperature of the coolant at the inlet to the air-conditioning compressor.

The control unit is preferably connected to a vehicle sensor system, wherein the temperature of the coolant entering the air-conditioning compressor can be calculated by the control unit on the basis of the data obtained from the vehicle sensor system, wherein, in particular, the vehicle sensor system detects an ambient temperature and/or an engine temperature and/or an engine speed and/or an air humidity and/or a blower power and/or speed of travel of the motor vehicle and/or a pressure of the coolant and/or a position of windows of the motor vehicle and/or a position of a top of the motor vehicle and/or a position of a control flap for a fresh air/recirculated air ratio. In particular, the vehicle sensor system is connected to the control unit, in particular by way of a vehicle information system, in particular a CAN bus. Using the data from the vehicle sensor system, the temperature of the coolant at the inlet to the air-conditioning compressor can be at least estimated, thus making it possible to dispense with direct measurement of the temperature with the aid of a separate temperature sensor.

As a particularly preferred option, a saved air-conditioning model is provided, wherein the temperature of the coolant entering the air-conditioning compressor can be calculated by the control unit by a comparison between the data obtained from the vehicle sensor system and the air-conditioning model. The air-conditioning model can have tables and/or diagrams, for example, by means of which the temperature of the coolant at the inlet to the air-conditioning compressor is correlated with a small number of input data. On account thereof it is possible to at least estimate the temperature of the coolant at the inlet to the air-conditioning compressor with sufficiently high accuracy and with little effort.

In particular, the heat exchanger has an outgoing line for delivering the coolant flowing to the evaporator and a return line for delivering the coolant coming from the evaporator, wherein the outgoing line and the return line are arranged substantially coaxially with one another. A high heat transfer capacity can be achieved through the coaxial alignment of the feed line and the return line.

A minimum flow path s is preferably provided between the evaporator and the condenser, and a minimum flow path S is provided between the evaporator and the air-conditioning compressor in the flow direction, wherein 10 cm≦s≦150 cm, in particular 30 cm≦s≦100 cm and preferably 50 cm≦s≦80 cm and/or 100 cm≦S≦400 cm, in particular 150 cm≦S≦350 cm and preferably 200 cm≦S≦300 cm applies. With such long flow paths between the evaporator and the condenser and/or between the condenser and the air-conditioning compressor, a significant temperature increase can occur in the refrigerant, although it is not possible for this temperature increase to damage the air-conditioning compressor, owing to the limitation of the temperature of the coolant with the aid of the control unit. This makes it possible to route lines for the coolant past different built-in components of the motor vehicle and to accept a particularly long flow path without compromising the service life of the air-conditioning compressor. To this end, the condenser can be arranged in a front area or in a rear area of the motor vehicle.

The invention further relates to a method for air conditioning a motor vehicle with the aid of a refrigeration system which, in particular, can be embodied and developed as described above, wherein the refrigeration system has an air-conditioning compressor, which can be driven by a mid or rear engine, for delivering a coolant, at least one evaporator for cooling a frontal part of the passenger compartment by evaporating the coolant, at least one condenser for condensing the coolant, and a heat exchanger for cooling the coolant flowing to the evaporator with cold from the coolant coming from the evaporator, in which a temperature of the coolant entering the air-conditioning compressor is limited. In particular, the method can be embodied and developed as explained above with reference to the refrigeration system. The temperature of the coolant entering the air-conditioning compressor is limited, in particular with the aid of a control unit. By limiting the temperature of the coolant at the inlet to the air-conditioning compressor, it is possible to avoid a temperature that is damaging to the air-conditioning compressor, even taking into account heating of the coolant along a particularly long flow path from the front area of the motor vehicle to the air-conditioning compressor arranged at the mid or rear engine, thus making possible a refrigeration system for a motor vehicle that has a long service life.

The invention is explained in the following by way of example below by means of preferred illustrative embodiments with reference to the attached drawings, wherein the features illustrated below can each represent one aspect of the invention, either individually or in combination.

### BRIEF DESCRIPTION OF THE DRAWINGS

FIG. 1 is a schematic block diagram of a refrigeration system.

FIG. 2 is a schematic perspective view of the refrigeration system of FIG. 1.

### DETAILED DESCRIPTION

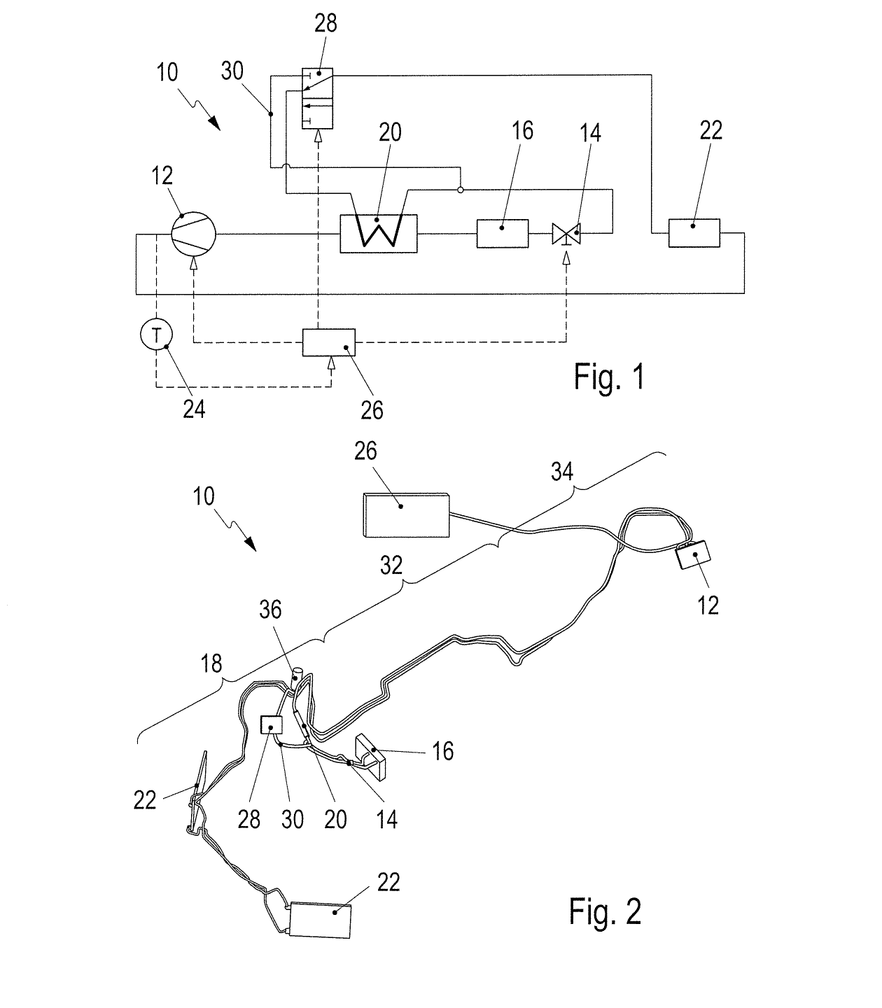

The refrigeration system 10 illustrated in FIG. 1 has an air-conditioning compressor 12 that delivers a coolant to a condenser 22. The coolant can be converted from a gaseous state to a liquid state. From the condenser 22, the coolant is fed to an evaporator 16 via an electrically controllable expansion valve 14. The evaporator 16 is arranged in a front area 18 of a motor vehicle, at one end in the direction of travel, in a passenger compartment to cool the passenger compartment in that the coolant evaporates within the evaporator 16. Here, the coolant leaving the condenser 22 is fed initially to an internal heat exchanger 20 to pre-cool the coolant fed to the expansion valve 14 and the evaporator 16 by way of the coolant leaving the evaporator 16. The coolant leaving the evaporator 16 heats up in corresponding fashion. After the coolant leaving the evaporator 16 has left the heat exchanger, the coolant is fed back to the air-conditioning compressor 12, resulting in a closed cooling circuit that can be part of an air-conditioning system of the motor vehicle.

In the illustrative embodiment shown, the temperature of the coolant fed to the air-conditioning compressor 12 is measured with the aid of a temperature sensor 24 and fed to a control unit 26. However, it is also possible for the temperature of the coolant fed to the air-conditioning compressor 12 to be at least estimated by other methods. If the temperature of the coolant fed to the air-conditioning compressor 12 should be too high, the control unit 26 can limit the temperature, with the control unit 26 initiating one or more measures among various possible options for control intervention. For example, the control unit 26 can vary the expansion in the expansion valve 14 in order to achieve greater cooling, for example. In addition or as an alternative, the capacity of the air-conditioning compressor 12 can be reduced by the control unit 26. In addition or as an alternative, the control unit 26 can reduce the heat exchanger capacity of the heat exchanger 20 in that at least some of the coolant coming from the condenser 22 is diverted past the heat exchanger 20 via a bypass line 30 with the aid of a bypass valve 28, which is provided as a branch valve designed as a 3/2-way valve, for example. In addition or as an alternative, the coolant coming from the evaporator 16 can be diverted past the heat exchanger 20. The bypass valve 28 can preferably direct one part of the delivery flow of the coolant via the heat exchanger 20 and another part via the bypass line 30.

As is illustrated in FIG. 2, the evaporator 16 is arranged in the front area 18. In the case of a motor vehicle with a rear engine, the air-conditioning compressor 12 is arranged adjacent to the rear engine in a rear area 34 spaced apart by a central area 32. In particular, the air-conditioning compressor 12 can be driven by the drive shaft, in particular the crankshaft, of the rear engine, e.g. by a belt drive. The air-conditioning compressor 12 preferably is attached directly to the rear engine. As a result, there is a relatively long flow path for the coolant between the evaporator 16 and the air-conditioning compressor 12. The path runs through the front area 18, the central area 32 and the rear area 34. In the illustrated exemplary embodiment, two condensers 22 are provided and are positioned, for example, in the vicinity of a wheel housing of the motor vehicle, at a position where the condensers 22 can be cooled by relative wind. It is also possible to provide the condensers 22 in the rear area 34. Moreover, a reservoir 36 is provided, where liquid coolant can be stored.

What is claimed is:

1. A refrigeration system for a motor vehicle with a mid engine or rear engine, comprising:
an air-conditioning compressor that can be driven by the mid or rear engine for delivering a coolant;
at least one evaporator for cooling a frontal part of the passenger compartment by evaporating the coolant
at least one condenser for condensing the coolant;
a heat exchanger for cooling the coolant flowing to the evaporator with cold from the coolant coming from the evaporator; and
a control unit for limiting a temperature of the coolant entering the air-conditioning compressor.

2. The refrigeration system of claim 1, wherein the control unit is connected to the air-conditioning compressor and is adapted to set a reduction in the operating capacity of the air-conditioning compressor to reduce a temperature of the coolant entering the air-conditioning compressor.

3. The refrigeration system of claim 1, wherein the control unit is connected to an expansion valve associated with the evaporator for expansion of the coolant, and the control unit is adapted to set a reduction in the expansion of the coolant in the expansion valve and/or in the evaporator to reduce the temperature of the coolant entering the air-conditioning compressor.

4. The refrigeration system of claim 1, further comprising a bypass line with a bypass valve for diverting at least some of the coolant flowing to the evaporator or some of the coolant coming from the evaporator past the heat exchanger, and the control unit being connected to the bypass valve and being operative to set an increase in the volume flow flowing via the bypass line to reduce the temperature of the coolant entering the air-conditioning compressor.

5. The refrigeration system of claim 1, further comprising a temperature sensor at an inlet of the air-conditioning compressor to measure the temperature of the coolant entering the air-conditioning compressor, the temperature sensor being connected to the control unit.

6. The refrigeration system of claim 1, further comprising a vehicle sensor system that is operative to detect at least one of an ambient temperature, an engine temperature, an engine speed, an air humidity, a blower power, speed of travel of the motor vehicle, a pressure of the coolant, a position of windows of the motor vehicle, a position of a top of the motor vehicle, and a position of a control flap for a fresh air/recirculated air ratio, and the control unit being connected to the vehicle sensor system and calculating the temperature of the coolant entering the air-conditioning compressor on a basis of data obtained from the vehicle sensor system.

7. The refrigeration system of claim 6, further comprising a storage with a saved air-conditioning model, and wherein the control unit is configured for calculating the temperature of the coolant entering the air-conditioning compressor by a comparison between the data obtained from the vehicle sensor system and the air-conditioning model.

8. The refrigeration system of claim 1, characterized in that the heat exchanger has an outgoing line for delivering the coolant flowing to the evaporator and a return line for delivering the coolant coming from the evaporator, the outgoing line and the return line being substantially coaxially with one another.

9. The refrigeration system of claim 1, further comprising a minimum flow path s between the evaporator and the condenser and a minimum flow path S between the evaporator and the air-conditioning compressor in the flow direction, wherein cm≦s≦150 cm and 100 cm≦S≦400 cm.

10. A method for air conditioning a motor vehicle with a mid or rear engine, the method comprising:
driving an air-conditioning compressor by a mid or rear engine for delivering a coolant;
operating at least one evaporator for evaporating the coolant and cooling a frontal part of the passenger compartment;
operating a condenser for condensing the coolant; and
using a heat exchanger for cooling the coolant flowing to the evaporator with cold from the coolant coming from the evaporator, whereby a temperature of the coolant entering the air-conditioning compressor is limited.
